(19) United States
(12) Patent Application Publication
(10) Pub. No.: US 2025/0252077 A1
(43) Pub. Date: Aug. 7, 2025

(54) METHOD AND APPARATUS WITH NEURAL NETWORK CHECKPOINT SAVING

(71) Applicant: SAMSUNG ELECTRONICS CO., LTD., Suwon-si (KR)

(72) Inventors: Junyeon LEE, Suwon-si (KR); Uiseok SONG, Suwon-si (KR); Byungwoo BANG, Suwon-si (KR)

(73) Assignee: SAMSUNG ELECTRONICS CO., LTD., Suwon-si (KR)

(21) Appl. No.: 18/893,143

(22) Filed: Sep. 23, 2024

(30) Foreign Application Priority Data
Feb. 1, 2024 (KR) 10-2024-0015968

(51) Int. Cl. G06F 16/11; G06F 16/17; G06F 16/182

(52) U.S. Cl. CPC G06F 16/128; G06F 16/1727; G06F 16/1824

(57) ABSTRACT

A processor-implemented method includes generating a checkpoint file of a neural network, determining, based on an available resource quantity of a group comprising nodes performing an operation corresponding to the checkpoint file, the number of splits of the checkpoint file, and storing the determined number of splits of the checkpoint file in the nodes in the group, respectively.

### CROSS-REFERENCE TO RELATED APPLICATIONS

This application claims the benefit under 35 USC § 119 (a) of Korean Patent Application No. 10-2024-0015968 filed on Feb. 1, 2024 in the Korean Intellectual Property Office, the entire disclosure of which is incorporated herein by reference for all purposes.

### BACKGROUND

### 1. Field

The following description relates to a method and apparatus with neural network checkpoint saving.

### 2. Description of Related Art

Checkpointing and restarting is a technique that stores and restores intermediate states of a neural network-based model during training. By periodically storing checkpoint files in a storage device such as a hard disk drive (HDD) or a solid-state drive (SSD) during training in case of a failure in training, even when an operation being computed is lost due to a failure in a node in the middle of computation for training, a previously stored checkpoint file may be retrieved, and the computation may continue from the middle point. In a large-scale distributed processing system such as a high-performance computer (HPC) and a supercomputer, there may be considerable input/output (I/O) and network overhead from checkpoints.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating a checkpoint file of a neural network, determining, based on an available resource quantity of a group comprising nodes performing an operation corresponding to the checkpoint file, the number of splits of the checkpoint file, and storing the determined number of splits of the checkpoint file in the nodes in the group, respectively.

The determining of the number of splits of the checkpoint file may include identifying available nodes among the nodes in the group, based on an available resource quantity of a storage device of each of the nodes in the group, and determining the number of the identified available nodes as the number of splits of the checkpoint file.

The storing in the nodes in the group may include storing the splits of the checkpoint file in respective storage devices of the identified available nodes, respectively.

The determining of the number of splits of the checkpoint file may include determining the number of splits of the checkpoint file based on the number of nodes performing the operation corresponding to the checkpoint file and the number of nodes comprised in the group.

The number of splits of the checkpoint file may be determined to be less than or equal to the number of nodes comprised in the group.

The splits of the checkpoint file may be stored in storage devices of the nodes in the group.

The method may include generating meta information and parity information corresponding to the checkpoint file, and storing the meta information and the parity information in a remote storage of a server system.

The checkpoint file may correspond to a first checkpoint, and the method may include determining whether to flush a second checkpoint file based on meta information of a second checkpoint immediately preceding the first checkpoint, and flushing the second checkpoint file into the remote storage based on a result of the determining.

In one or more general aspects, a non-transitory computer-readable storage medium may store instructions that, when executed by one or more processors, configure the one or more processors to perform any one, any combination, or all of operations and/or methods discussed herein.

In one or more general aspects, a processor-implemented method includes splitting a first checkpoint file corresponding to a first checkpoint of a neural network and storing the first checkpoint file in nodes in a group, storing meta information of the first checkpoint in a remote storage of a server system, determining whether to flush a second checkpoint file based on meta information of a second checkpoint immediately preceding the first checkpoint, and flushing the second checkpoint file into the remote storage based on a result of the determining.

The flushing of the second checkpoint file may include in response to the second checkpoint file being determined to be a flushing target to be flushed, flushing the second checkpoint file into the remote storage, and, in response to the second checkpoint file being determined not to be the flushing target, deleting the second checkpoint file stored in one or more nodes of the server system.

The method may include, in response to the second checkpoint file being determined not to be the flushing target, deleting meta information and parity information of the second checkpoint stored in the remote storage.

The determining of whether to flush the second checkpoint file may include determining whether to flush the second checkpoint file based on a tag value comprised in the meta information of the second checkpoint, the tag value indicating whether the second checkpoint is a flushing target to be flushed.

The splitting and storing of the first checkpoint file in the nodes in the group may include determining, based on an available resource quantity of the group comprising nodes performing an operation corresponding to the first checkpoint file, the number of splits of the first checkpoint file, and storing the determined number of splits of the first checkpoint file in the nodes in the group, respectively.

In one or more general aspects, an apparatus includes one or more processors configured to generate a checkpoint file of a neural network, determine, based on an available resource quantity of a group comprising nodes performing an operation corresponding to the checkpoint file, the number of splits of the checkpoint file, and store the determined number of splits of the checkpoint file in the nodes in the group, respectively.

For the determining of the number of splits of the checkpoint file, the one or more processors may be configured to identify available nodes among the nodes in the group, based on an available resource quantity of a storage device of each of the nodes in the group, and determine the number of the identified available nodes as the number of splits of the checkpoint file.

For the storing of the determined number of splits of the checkpoint file in the nodes in the group, the one or more processors may be configured to store the splits of the checkpoint file in respective storage devices of the identified available nodes, respectively.

For the determining of the number of splits of the checkpoint file, the one or more processors may be configured to determine the number of splits of the checkpoint file based on the number of nodes performing the operation corresponding to the checkpoint file and the number of nodes comprised in the group.

In one or more general aspects, an apparatus includes one or more processors configured to split a first checkpoint file corresponding to a first checkpoint of a neural network and store the first checkpoint file in nodes in a group, store meta information of the first checkpoint in a remote storage of a server system configured to store checkpoints of the neural network, determine whether to flush a second checkpoint file based on meta information of a second checkpoint immediately preceding the first checkpoint, and flush the second checkpoint file into the remote storage based on a result of the determining.

For the flushing of the second checkpoint file, the one or more processors may be configured to, in response to the second checkpoint file being determined to be a flushing target to be flushed, flush the second checkpoint file into the remote storage, and, in response to the second checkpoint file being determined not to be the flushing target, delete the second checkpoint file stored in one or more nodes of the server system.

Other features and aspects will be apparent from the following detailed description, the drawings, and the claims.

### BRIEF DESCRIPTION OF THE DRAWINGS

FIG. 1 illustrates an example operational flow of a method of storing checkpoints of a neural network according to one or more example embodiments.

FIG. 2 illustrates an example server system according to one or more example embodiments.

FIGS. 3A through 3C illustrate an example process of storing a split checkpoint file in a storage device of a node according to one or more example embodiments.

FIGS. 4A and 4B illustrate an example process of storing a split checkpoint file in a storage device of a node according to one or more example embodiments.

FIG. 5 illustrates an example operational flow of a method of storing checkpoints of a neural network according to one or more example embodiments.

FIG. 6 illustrates example meta information of a checkpoint according to one or more example embodiments.

FIG. 7 illustrates an example process of determining whether to delete a checkpoint file based on whether it is subject to flushing according to one or more example embodiments.

FIG. 8 illustrates an example configuration of an apparatus according to one or more example embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. It should be appreciated that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, example embodiments will be described in detail with reference to the accompanying drawings. When describing the examples with reference to the accompanying drawings, like reference numerals refer to like components and a repeated description related thereto is omitted.

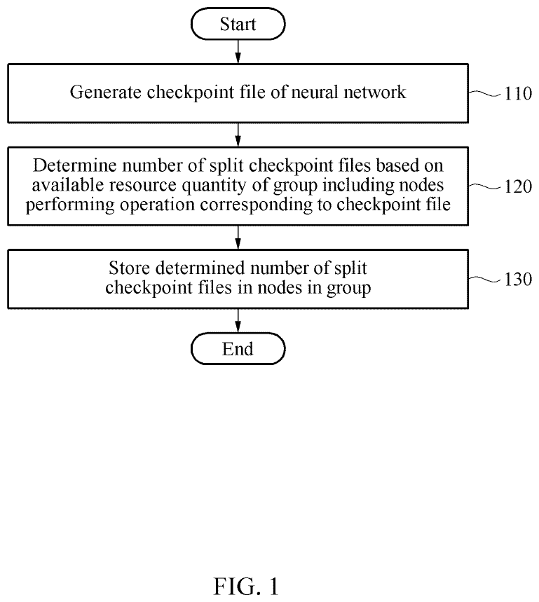

FIG. 1 illustrates an example operational flow of a method of storing checkpoints of a neural network according to one or more example embodiments. Operations 110 to 130 to be described hereinafter may be performed sequentially in the order and manner as shown and described below with reference to FIG. 1, but the order of one or more of the operations may be changed, one or more of the operations may be omitted, and two or more of the operations may be performed in parallel or simultaneously without departing from the spirit and scope of the example embodiments described herein.

Hereinafter, the method of storing checkpoints of a neural network will be referred to simply as a “checkpoint storing method.”

A method and apparatus of one or more embodiments may improve the computation of storing and restoring checkpoints while minimizing the overhead to ensure workload reliability. According to one or more embodiments, the checkpoint storing method may be performed on a server system including a plurality of nodes (or servers). The server system may include, for example, a computer cluster, a high-performance computing (HPC) server, and/or a supercomputer. The nodes included in the server system may be computational nodes that perform computation operations of a neural network. The server system may include a network architecture with a plurality of layers. According to one or more embodiments, the checkpoint storing method may be performed by a control device of the server system and/or a processor for controlling the server system.

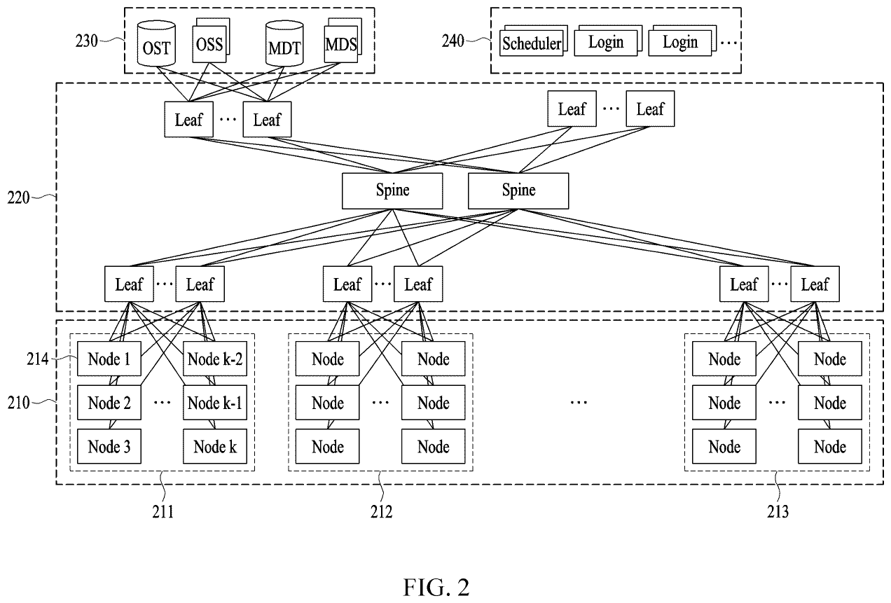

In an example, referring to FIG. 2, the server system may include a plurality of nodes 210, a switch 220 for node communication, a remote storage 230, and a management module 240 for server management.

The remote storage 230 may include a storage device connected to a node over a network. The remote storage 230 may include, for example, a network file system (NFS) and/or a distributed file system (DFS).

The switch 220 may include switches of a plurality of layers. In an example, a switch (e.g., “leaf”) of a first layer may be connected to an end device including nodes and a remote storage, and a switch (e.g., “spine”) of a second layer may be connected to the switch of the first layer. Nodes may communicate with each other through switches in the first layer, and the switches in the first layer may communicate with each other through switches in the second layer.

Nodes that may communicate with each other via a switch of the first layer may be grouped into a group (or “pot” or “pod”). In an example, the server system may include nodes grouped into N groups including a first group 211, a second group 212, and a third group 213. The first group 211 may include k nodes.

According to one or more embodiments, the checkpoint storing method may include operation 110 of generating a checkpoint file of the neural network. A checkpoint of the neural network may refer to a specific point in time during a training process of the neural network at which parameters (e.g., weights) of the neural network are stored, and a checkpoint file of the neural network may include a file storing the parameters of the neural network at the specific point in time during the training process of the neural network. In an example, the checkpoint may be determined at predetermined time intervals, may be determined by user settings by a user, and/or may be determined by a period of the number of times an iteration of training is performed.

According to one or more embodiments, the checkpoint storing method may include operation 120 of determining the number of split checkpoint files based on an available resource quantity of a group including nodes that perform a computation operation corresponding to the checkpoint file. The nodes performing the operation corresponding to the checkpoint file may include one or more nodes on which an operation of the neural network corresponding to a checkpoint is performed. Hereinafter, a node performing an operation corresponding to a checkpoint file will be referred to as a “working node.”

A group including a working node may include one or more nodes connected to the working node via a switch in the first layer. Hereinafter, the group including the working node will be referred to as a “target group.” For example, when node 1 214 shown in FIG. 2 is a working node, the first group 211 may correspond to a target group including the node 1 214 which is the working node.

The number of split checkpoint files may be determined to be less than or equal to the number of nodes in a target group. For example, when the target group includes k nodes, the number of splits may be determined to be k or less.

An available resource quantity of the target group may be an available resource quantity of storage devices of nodes included in the target group. In this case, a storage device of a node in the target group may include at least one of a local storage and a memory of the node.

According to one or more embodiments, operation 120 of determining the number of split checkpoint files may include identifying available nodes among the nodes included in the target group based on an available resource quantity of a storage device of each of the nodes in the target group.

An available node may be a node that includes a storage device configured to store at least a portion of a checkpoint file. For example, when an available resource quantity of a storage device of a node is greater than or equal to a threshold value, the node may be identified as an available node. In an example, the available node may be identified based on a comparison of an available resource quantity of a storage device of a node and the size of the checkpoint file.

For example, when an available resource quantity of a storage device of a node is greater than or equal to a value obtained by dividing the size of a checkpoint file by n (where “n” is any natural number), and the available resource quality of the storage device of the node is at or below an nth rank position in the target group, the node may be identified as the available node.

According to one or more embodiments, operation 120 of determining the number of split checkpoint files may include determining the number of the identified available nodes as the number of split checkpoint files. That is, the number of identified available nodes in a target group may be determined as the number of splits of a checkpoint file.

According to one or more embodiments, operation 120 of determining the number of split checkpoint files may include determining the number of split checkpoint files based on the number of working nodes performing the operation corresponding to the checkpoint file and the number of nodes included in the target group. The number of split checkpoint files, e.g., the number of splits of the checkpoint file, may be determined based on the number of working nodes. For example, when the number of working nodes is at least half (or more) the number of nodes in the target group, the number of split checkpoint files may be determined as the number of nodes in the target group. That is, when the number of nodes in the target group is k and the number of working nodes in the target group is k/2 or more, the number of split checkpoint files may be determined to be k.

According to one or more embodiments, the checkpoint storing method may include operation 130 of storing the determined number of split checkpoint files in the nodes in the group, respectively. When the determined number of splits is “n,” the checkpoint file may be split into n equal sized files or into n unequal sized files. The split checkpoint files may be stored in the storage devices of the nodes in the target group.

According to one or more embodiments, operation 130 of storing the split checkpoint files in the nodes in the group may include storing the split checkpoint files in respective storage devices of the identified available nodes. That is, the split checkpoint files may be distributed and stored into the storage devices of the available nodes in the target group. For example, when the number of split checkpoint files is three, and a first node, a second node, and a third node are the available nodes included in the target group, the checkpoint file may be split into the three splits and stored in a storage device of the first node, a storage device of the second node, and a storage device of the third node, respectively. By distributing and storing the split checkpoint files into the storage devices of the nodes, the method and apparatus of one or more embodiments may reduce routing overhead for storing the checkpoint file.

According to one or more embodiments, the checkpoint storing method may include generating meta information and parity information corresponding to the checkpoint file, and storing the meta information and the parity information in a remote storage of the server system.

The parity information corresponding to the checkpoint file may be information for restoring the checkpoint file. The meta information corresponding to the checkpoint file may be structured information of information about the checkpoint file and may include at least one of, for example, information about a location of a storage device of a node in which a split checkpoint file is stored, information about the number of splits of the checkpoint file, information about a location in which the parity information corresponding to the checkpoint file is stored, information about meta information corresponding to another checkpoint file, information about whether the checkpoint file is subject to flushing, and/or identification information of the checkpoint file.

The meta information and the parity information corresponding to the checkpoint file may be stored in the remote storage of the server system. The meta information and the parity information corresponding to the checkpoint file may be smaller in size than the checkpoint file. For example, when the number of splits of the checkpoint file is “n,” the meta information and the parity information corresponding to the checkpoint file may be on the order of 1/n of the size of the checkpoint file.

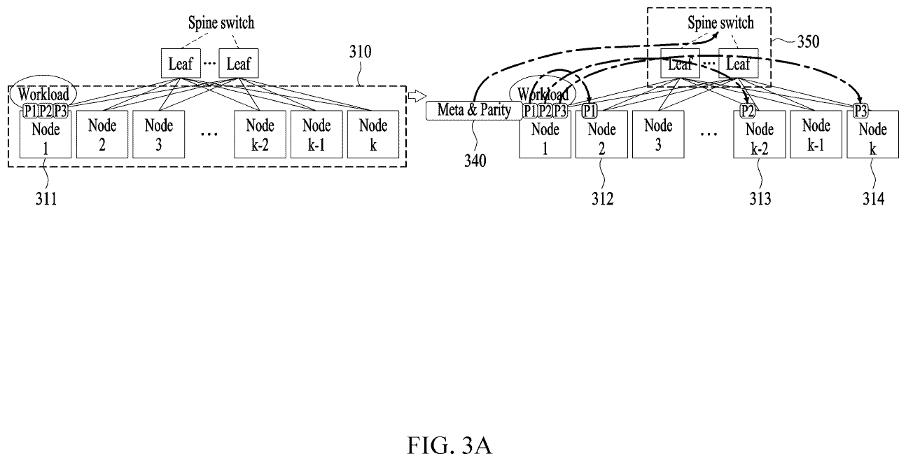

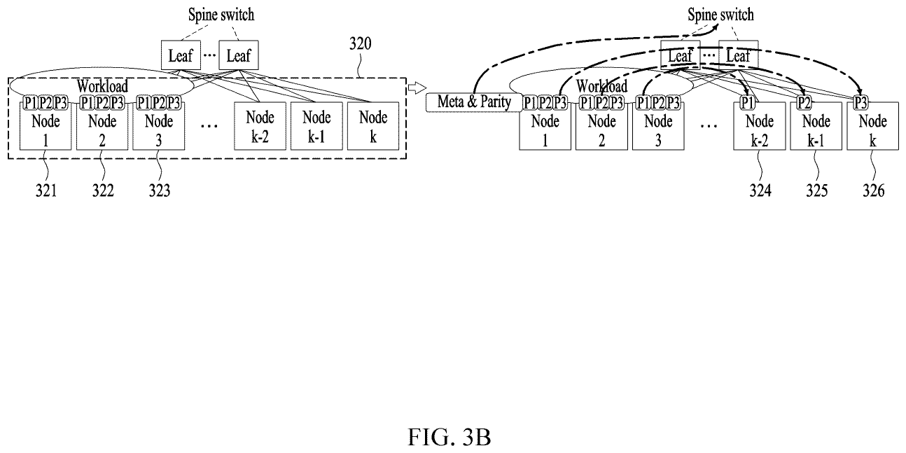

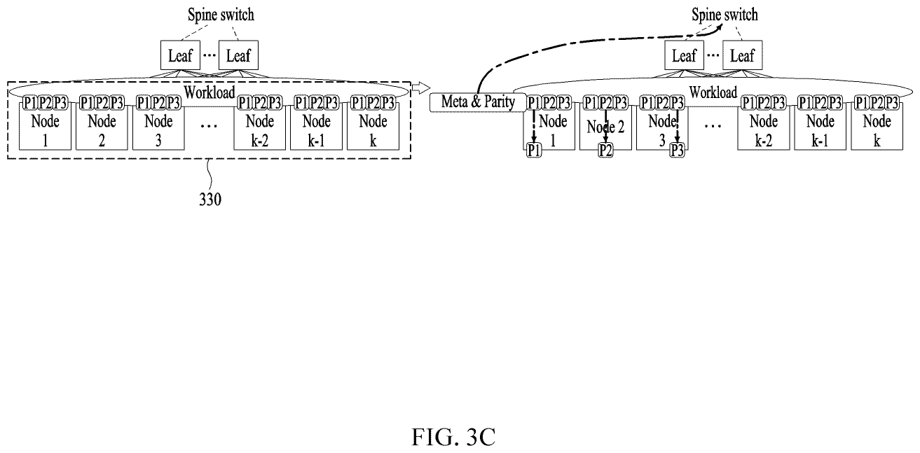

FIGS. 3A through 3C illustrate an example process of storing a split checkpoint file in a storage device of a node according to one or more example embodiments.

FIGS. 3A through 3C illustrate how a split checkpoint file is stored in a storage device of a node in a target group, when each working node includes the entire information of a checkpoint file. For example, as shown in FIGS. 3A to 3C, a group (e.g., each of groups 310, 320, and 330) may include k nodes.

FIG. 3A illustrates an example process of storing a split checkpoint file in a storage device of a node when there is one working node.

Referring to FIG. 3A, node 1 311 may be a working node that performs an operation corresponding to a checkpoint file. When the number of split checkpoint files is determined to be three, three available nodes may be selected from among nodes included in a group 310 to which the node 1 311 belongs. The three split checkpoint files may be stored in a storage device of node 2 312, a storage device of node k-2 313, and a storage device of node k 314 selected as the available node, respectively. In this case, meta information and parity information 340 corresponding to the checkpoint file may be stored in a remote storage via switches 350 of a plurality of layers.

When a split checkpoint file is transferred to another node in a target group, it may be transferred through a switch in a first layer. A data transfer amount when the split checkpoint file is transferred to another node in the target group may be less than a data transfer amount when the split checkpoint file is transferred to a node in another group or transferred to the remote storage through a switch in a second layer. For example, the data transfer amount when the split checkpoint file is transferred to another node in the target group may be half the data transfer amount when the split checkpoint file is transferred to a node in another group or transferred to the remote storage through the switch in the second layer. The meta information and parity information 340 corresponding to the checkpoint file may be transferred through a switch of the first layer and a switch of the second layer to be transferred to the remote storage. The meta information and parity information 340 corresponding to the checkpoint file may correspond to data of relatively small size compared to the checkpoint file. By only transferring the meta information and parity information 340 corresponding to a small-sized checkpoint file to the remote storage, and by splitting and transferring the checkpoint file to nodes in the target group, the method and apparatus of one or more embodiments may reduce the network routing overhead for data transmission.

FIG. 3B illustrates an example process of storing a split checkpoint file in a storage device of a node when there are three working nodes.

Referring to FIG. 3B, node 1 321, node 2 322, and node 3 323 may be working nodes that perform an operation corresponding to a checkpoint file. The node 1 321, the node 2 322, and the node 3 323, which are the working nodes, may each include the entire information of the checkpoint file. When the number of split checkpoint files is determined to be three, three available nodes may be selected from among nodes included in a group 320 to which the node 1 321, the node 2 322, and the node 3 323 belong. The three split checkpoint files may be stored in respective storage devices of node k-2 324, node k-1 325, and node k 326 selected as the available nodes, respectively.

FIG. 3C illustrates an example process of storing a split checkpoint file in a storage device of a node when there are k working nodes.

Referring to FIG. 3C, all k nodes included in a group 330 may be working nodes that perform an operation corresponding to a checkpoint file. The k nodes, which are working nodes, may each include the entire information of the checkpoint file. In an example, when the number of working nodes is half or more than half the number of nodes included in the target group, the number of split checkpoint files may be determined to be the number of nodes included in the target group. For example, when all the nodes included in the group 330 are working nodes, the number of working nodes may be more than k/2, and the number of split checkpoint files may therefore be determined to be k. The k split checkpoint files may be stored in respective storage devices of the nodes in the group 330.

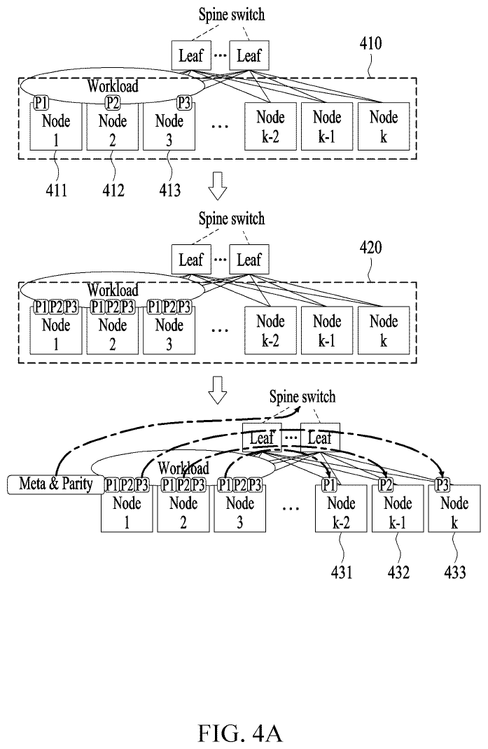

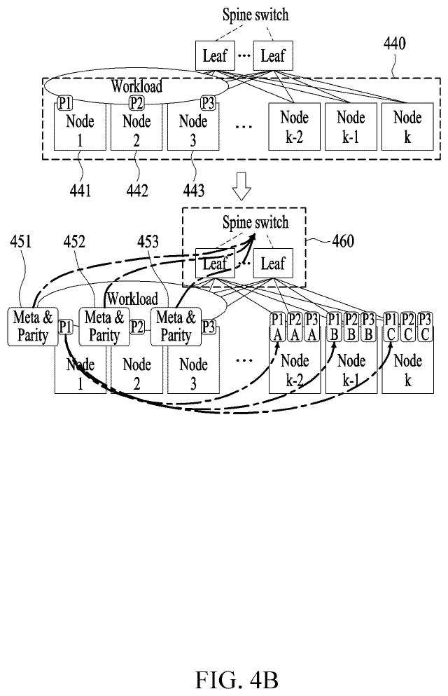

FIGS. 4A and 4B illustrate an example process of storing a split checkpoint file in a storage device of a node according to one or more example embodiments.

FIGS. 4A and 4B illustrate how a split checkpoint file is stored in a storage device of a node in a target group when each working node includes some partial information of a checkpoint file. That one working node includes partial information of a checkpoint file may indicate that the node includes only information of some of parameters of a neural network, rather than including information of all the parameters of the neural network. For example, when a first node and a second node are working nodes, the first node may include information of a portion of the parameters of the neural network corresponding to a checkpoint, and the second node may include information of another portion of the parameters of the neural network that is different from the portion of the parameters included in the first node. For example, in a model parallelism method of a distributed training method of the neural network, each working node performing an operation may include only partial information of a checkpoint file. For example, as shown in FIGS. 4A and 4B, a group (e.g., each of groups 410 and 440) may include k nodes.

FIG. 4A illustrates an example process of storing a split checkpoint file in a storage device of a node in response to collecting parameters of a neural network corresponding to a checkpoint distributed to each working node.

Referring to FIG. 4A, node 1 411, node 2 412, and node 3 413 may be working nodes that perform an operation corresponding to a checkpoint file. As described above with reference to FIG. 3B, the node 1 411, the node 2 412, and the node 3 413, which are the working nodes, may each include partial information of the checkpoint file, and no working node may have entire information of all parameters of a neural network corresponding to a checkpoint.

In this case, to generate parity information corresponding to the checkpoint file, an operation of collecting parameter information of the neural network corresponding to the checkpoint distributed to the working nodes may precede. In an example, the parameter information of the neural network corresponding to the checkpoint distributed to the working nodes may be collected or gathered at one working node through an “allreduce” operation. In an example, the parameter information of the neural network corresponding to the checkpoint distributed to the working nodes may be shared by all the working nodes through an “allgather” operation. For example, the parameter information of the neural network corresponding to the distributed checkpoint may be shared with working nodes 420 through the allgather operation.

As described above, “t” available nodes (where “t” is any natural number) may be selected from among nodes included in the group 410 to which the node 1 411, the node 2 412, and the node 3 413 belong. In respective storage devices of the selected t available nodes, t split checkpoint files may be stored, respectively. For example, as shown, three split checkpoint files may be stored in respective storage devices of node k-2 431, node k-1 432, and node k 433 selected as the available nodes.

FIG. 4B illustrates an example process of storing a split checkpoint file in a storage device of a node without collecting parameters of a neural network corresponding to a checkpoint distributed to each working node.

Referring to FIG. 4B, node 1 441, node 2 442, and node 3 443 may be working nodes that perform an operation corresponding to a checkpoint file. As described above with reference to FIG. 4A, the node 1 441, the node 2 442, and the node 3 443, which are the working nodes, may each include some partial information of the checkpoint file, and no working node may have the entire information of all parameters of a neural network corresponding to a checkpoint.

Unlike the example process described above with reference to FIG. 4A, meta information and parity information corresponding to the parameters of the neural network corresponding to the checkpoint distributed to each working node may be generated without collecting parameter information of the neural network corresponding to the checkpoint distributed to each working node. For example, in response to one checkpoint file, meta information and parity information 451 corresponding to parameters of the neural network stored in the node 1 441, meta information and parity information 452 corresponding to parameters of the neural network stored in the node 2 442, and meta information and parity information 453 corresponding to parameters of the neural network stored in the node 3 443 may be generated. The three generated meta information and parity information 451, 452, and 453 may be stored in a remote storage through switches 460 of a plurality of layers.

In this case, a network load for sharing the parameters of the neural network between working nodes may be reduced, but meta information and parity information may be generated multiple times.

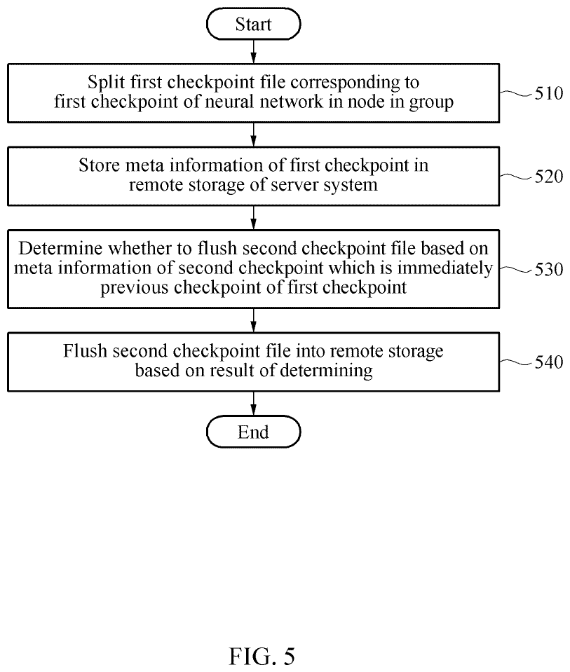

FIG. 5 illustrates an example operational flow of a method of storing checkpoints of a neural network according to one or more example embodiments. Operations 510 to 540 to be described hereinafter may be performed sequentially in the order and manner as shown and described below with reference to FIG. 5, but the order of one or more of the operations may be changed, one or more of the operations may be omitted, and two or more of the operations may be performed in parallel or simultaneously without departing from the spirit and scope of the example embodiments described herein.

Referring to FIG. 5, according to one or more embodiments, a checkpoint storing method may include operation 510 of splitting a first checkpoint file corresponding to a first checkpoint of a neural network and storing it in a node in a group.

According to one or more embodiments, operation 510 of splitting the first checkpoint file and storing the first checkpoint file in the node in the group may include determining the number of split first checkpoint files based on an available resource quantity of the group including nodes that perform an operation corresponding to the first checkpoint file, and storing the determined number of split first checkpoint files in the nodes in the group, respectively.

In an example, operation 510 may also be performed in response to operation 540 being performed. In an example, the first checkpoint file and meta information corresponding to the first checkpoint file may be generated before operation 520 is performed, and operation 510 of splitting the first checkpoint file and storing it in the node in the group may be performed in response to operation 540 being performed.

According to one or more embodiments, the checkpoint storing method may include operation 520 of storing meta information of a first checkpoint in a remote storage of a server system. The meta information of the first checkpoint may correspond to the meta information corresponding to the first checkpoint file.

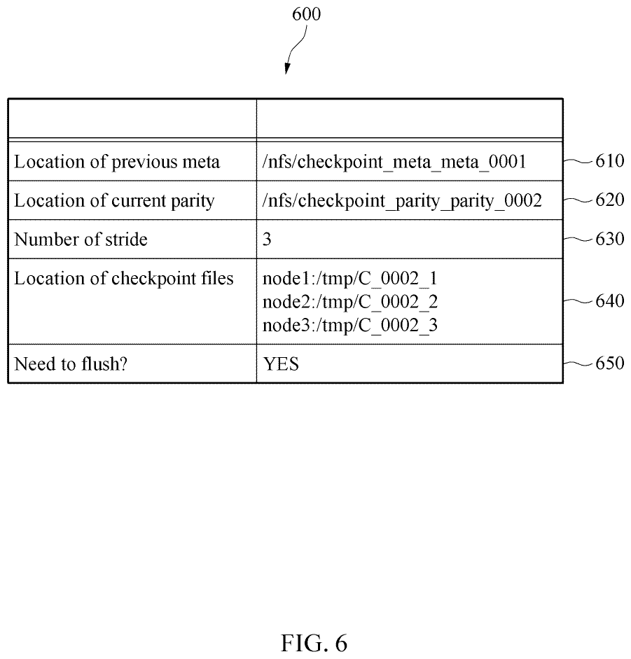

For example, referring to FIG. 6, meta information 600 of a checkpoint may include information 610 about a location at which meta information of a previous checkpoint is stored, information 620 about a location at which parity information corresponding to a checkpoint file is stored, information 630 about the number of splits of the checkpoint file, information 640 about a location of a storage device of a node in which a split checkpoint file is stored, and/or information 650 about whether the checkpoint file is subject to flushing.

For example, whether a checkpoint file is subject to flushing may be determined by user settings by a user. In an example, whether a checkpoint file is subject to flushing may be determined based on a predetermined period. In an example, whether a checkpoint file is subject to flushing may be determined based on a period of the number of times an iteration of training is performed. In an example, whether a checkpoint file is subject to flushing may be determined arbitrarily.

According to one or more embodiments, the checkpoint storing method may include operation 530 of determining whether to flush a second checkpoint file based on meta information of a second checkpoint immediately preceding the first checkpoint.

According to one or more embodiments, operation 530 of determining whether to flush the second checkpoint file may include determining whether to flush the second checkpoint file based on a tag value included in the meta information of the second checkpoint that indicates whether the second checkpoint is subject to flushing. The tag value may be determined to be a value (e.g., 1) indicating that the second checkpoint is a flushing target to be flushed, or a value (e.g., 0) indicating that the second checkpoint is not the flushing target. In an example, as shown in FIG. 6, based on the information 650 about whether the checkpoint file (e.g., the second checkpoint file) is subject to flushing, which is included in the meta information of the second checkpoint file, whether to flush the second checkpoint file may be determined.

According to one or more embodiments, the checkpoint storing method may include operation 540 of flushing the second checkpoint file into the remote storage based on a result of the determining. Here, flushing may refer to recording or writing data stored in a storage device of a node into the remote storage.

In an example, when the second checkpoint file is determined to be the flushing target, operation 540 of flushing the second checkpoint file may include flushing the second checkpoint file into the remote storage. In an example, when the second checkpoint file is determined not to be the flushing target, the checkpoint storing method may include deleting the second checkpoint file stored in at least some of the nodes of the server system. When the first checkpoint file is generated and stored in a node, the second checkpoint file may be deleted from a storage device of the node. Even when the second checkpoint file is subject to flushing and is stored in the remote storage, the second checkpoint file may also be deleted from the storage device of the node.

According to one or more embodiments, when the second checkpoint file is determined not to be the flushing target, the checkpoint storing method may further include deleting meta information and parity information of the second checkpoint stored in the remote storage.

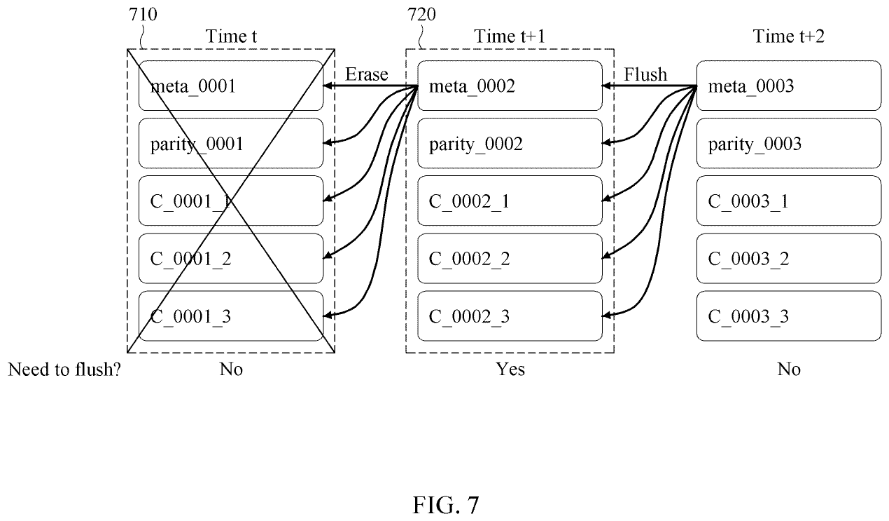

For example, referring to FIG. 7, when a checkpoint file is generated at a time t+1, whether a checkpoint file at a time t is subject to flushing may be determined. When the checkpoint file at the time t is determined not to be a flushing target, checkpoint information 710 of the time t that includes split checkpoint files at the time t and includes meta information and parity information corresponding to the checkpoint file at the time t may be deleted.

When a checkpoint file is generated at a time t+2, whether the checkpoint file at the time t+1 is subject to flushing may be determined. When the checkpoint file at the time t+1 is determined to be the flushing target, the checkpoint file of the time t+1 may be flushed into the remote storage, and meta information and parity information corresponding to the checkpoint file of the time t+1 stored in the remote storage may be retained. That is, when the checkpoint file of the time t+1 is the flushing target, checkpoint information 720 of the time t+1 that includes split checkpoint files at the time t+1 and includes the meta information and parity information corresponding to the checkpoint file at the time t+1 may be deleted.

Based on the determination of the flushing target, the method and apparatus of one or more embodiments may only store some checkpoint files in the remote storage, which may ensure the reliability of checkpoint files.

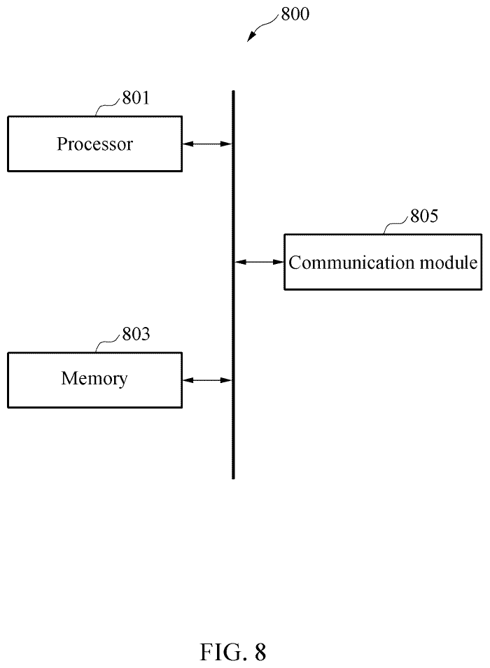

FIG. 8 illustrates an example configuration of an apparatus according to one or more example embodiments.

Referring to FIG. 8, according to one or more embodiments, an apparatus 800 may include a processor 801 (e.g., one or more processors), a memory 803 (e.g., one or more memories), and a communication module 805. The apparatus 800 may include an apparatus that stores checkpoints of a neural network. In an example, the apparatus 800 may include an apparatus that performs the checkpoint storing method described above with reference to FIGS. 1 through 7. In an example, the apparatus 800 may be an apparatus related to the server system described above and may include, for example, an apparatus that controls the server system described above.

According to one or more embodiments, the processor 801 may perform at least one of the operations or processes described above with reference to FIGS. 1 through 7. For example, the processor 801 may perform at least one of the following operations: generating a checkpoint file of the neural network; determining the number of split checkpoint files based on an available resource quantity of a group including nodes performing an operation corresponding to the checkpoint file; and storing the determined number of split checkpoint files in the nodes in the group, respectively. For example, the processor 801 may perform at least one of the following operations: splitting a first checkpoint file corresponding to a first checkpoint of the neural network and storing it in a node in a group; storing meta information of the first checkpoint in a remote storage of the server system; determining whether to flush a second checkpoint file based on meta information of a second checkpoint immediately preceding the first checkpoint; and flushing the second checkpoint file into the remote storage based on a result of the determining.

According to one or more embodiments, the memory 803 may be a volatile memory or a non-volatile memory and may store data related to the checkpoint storing method described above with reference to FIGS. 1 through 7. In an example, the memory 803 may store data generated during the checkpoint storing method or data required to perform the checkpoint storing method.

In an example, the memory 803 may store a program in which the checkpoint storing method described above with reference to FIGS. 1 through 7 is implemented. The processor 801 may execute the program stored in the memory 803 and control the apparatus 800, and a code of the program executed by the processor 801 may be stored in the memory 803. For example, the memory 803 may include a non-transitory computer-readable storage medium storing instructions that, when executed by the processor 801, configure the processor 801 to perform any one, any combination, or all of the operations and/or methods described above with reference to FIGS. 1 through 7.

In an example, the memory 803 may include storage devices of nodes and the remote storage described above.

According to one or more embodiments, the communication module 805 may provide a function for the apparatus 800 to communicate with other electronic devices or other servers over a network. That is, through the communication module 805, the apparatus 800 may be connected to external devices (e.g., user terminals, servers, or networks) and exchange data with the external devices.

According to one or more embodiments, the apparatus 800 may further include other components not shown. The apparatus 800 may further include, for example, an input/output interface including an input device and an output device for interfacing with the communication module 805. The apparatus 800 may further include, for example, other components such as a transceiver, various sensors, a database (DB), and the like.

The nodes, switches, remote storages, management modules, groups, second groups, third groups, storage devices, working nodes, apparatuses, processors, memories, communication modules, nodes 210, switch 220, remote storage 230, management module 240, first group 211, second group 212, third group 213, node 1 214, groups 310, 320, and 330, node 1 311, node 2 312, storage device of node k-2 313, storage device of node k 314, switches 350, node 1 321, node 2 322, node 3 323, storage devices of node k-2 324, node k-1 325, and node k 326, groups 410 and 440, node 1 411, node 2 412, node 3 413, working nodes 420, storage devices of node k-2 431, node k-1 432, and node k 433, node 1 441, node 2 442, node 3 443, switches 460, apparatus 800, processor 801, memory 803, and communication module 805 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11C that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating a checkpoint file of a neural network;
determining, based on an available resource quantity of a group comprising nodes performing an operation corresponding to the checkpoint file, the number of splits of the checkpoint file; and
storing the determined number of splits of the checkpoint file in the nodes in the group, respectively.

2. The method of claim 1, wherein the determining of the number of splits of the checkpoint file comprises:
identifying available nodes among the nodes in the group, based on an available resource quantity of a storage device of each of the nodes in the group; and
determining the number of the identified available nodes as the number of splits of the checkpoint file.

3. The method of claim 2, wherein the storing in the nodes in the group comprises storing the splits of the checkpoint file in respective storage devices of the identified available nodes, respectively.

4. The method of claim 1, wherein the determining of the number of splits of the checkpoint file comprises determining the number of splits of the checkpoint file based on the number of nodes performing the operation corresponding to the checkpoint file and the number of nodes comprised in the group.

5. The method of claim 1, wherein the number of splits of the checkpoint file is determined to be less than or equal to the number of nodes comprised in the group.

6. The method of claim 1, wherein the splits of the checkpoint file are stored in storage devices of the nodes in the group.

7. The method of claim 1, further comprising:
generating meta information and parity information corresponding to the checkpoint file; and
storing the meta information and the parity information in a remote storage of a server system.

8. The method of claim 7,
wherein the checkpoint file corresponds to a first checkpoint, and
further comprising:
determining whether to flush a second checkpoint file based on meta information of a second checkpoint immediately preceding the first checkpoint; and
flushing the second checkpoint file into the remote storage based on a result of the determining.

9. A non-transitory computer-readable storage medium storing instructions that, when executed by one or more processors, configure the one or more processors to perform the method of claim 1.

10. A processor-implemented method comprising:
splitting a first checkpoint file corresponding to a first checkpoint of a neural network and storing the first checkpoint file in nodes in a group;
storing meta information of the first checkpoint in a remote storage of a server system;
determining whether to flush a second checkpoint file based on meta information of a second checkpoint immediately preceding the first checkpoint; and
flushing the second checkpoint file into the remote storage based on a result of the determining.

11. The method of claim 10, wherein the flushing of the second checkpoint file comprises:
in response to the second checkpoint file being determined to be a flushing target to be flushed, flushing the second checkpoint file into the remote storage; and
in response to the second checkpoint file being determined not to be the flushing target, deleting the second checkpoint file stored in one or more nodes of the server system.

12. The method of claim 11, further comprising, in response to the second checkpoint file being determined not to be the flushing target, deleting meta information and parity information of the second checkpoint stored in the remote storage.

13. The method of claim 10, wherein the determining of whether to flush the second checkpoint file comprises determining whether to flush the second checkpoint file based on a tag value comprised in the meta information of the second checkpoint, the tag value indicating whether the second checkpoint is a flushing target to be flushed.

14. The method of claim 10, wherein the splitting and storing of the first checkpoint file in the nodes in the group comprises:
determining, based on an available resource quantity of the group comprising nodes performing an operation corresponding to the first checkpoint file, the number of splits of the first checkpoint file; and
storing the determined number of splits of the first checkpoint file in the nodes in the group, respectively.

15. An apparatus comprising:
one or more processors configured to:
generate a checkpoint file of a neural network;
determine, based on an available resource quantity of a group comprising nodes performing an operation corresponding to the checkpoint file, the number of splits of the checkpoint file; and
store the determined number of splits of the checkpoint file in the nodes in the group, respectively.

16. The apparatus of claim 15, wherein, for the determining of the number of splits of the checkpoint file, the one or more processors are configured to:
identify available nodes among the nodes in the group, based on an available resource quantity of a storage device of each of the nodes in the group; and
determine the number of the identified available nodes as the number of splits of the checkpoint file.

17. The apparatus of claim 16, wherein, for the storing of the determined number of splits of the checkpoint file in the nodes in the group, the one or more processors are configured to store the splits of the checkpoint file in respective storage devices of the identified available nodes, respectively.

18. The apparatus of claim 15, wherein, for the determining of the number of splits of the checkpoint file, the one or more processors are configured to determine the number of splits of the checkpoint file based on the number of nodes performing the operation corresponding to the checkpoint file and the number of nodes comprised in the group.

19. An apparatus comprising:
one or more processors configured to:
split a first checkpoint file corresponding to a first checkpoint of a neural network and store the first checkpoint file in nodes in a group;
store meta information of the first checkpoint in a remote storage of a server system configured to store checkpoints of the neural network;
determine whether to flush a second checkpoint file based on meta information of a second checkpoint immediately preceding the first checkpoint; and
flush the second checkpoint file into the remote storage based on a result of the determining.

20. The apparatus of claim 19, wherein, for the flushing of the second checkpoint file, the one or more processors are configured to:
in response to the second checkpoint file being determined to be a flushing target to be flushed, flush the second checkpoint file into the remote storage; and
in response to the second checkpoint file being determined not to be the flushing target, delete the second checkpoint file stored in one or more nodes of the server system.
